(19) United States
(12) Patent Application Publication
(10) Pub. No.: US 2010/0217852 A1
(43) Pub. Date: Aug. 26, 2010

(54) Wireless Terminal Device and Server Therefor

(75) Inventor: Asako Nishida, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/711,601

(22) Filed: Feb. 24, 2010

(30) Foreign Application Priority Data
Feb. 26, 2009 (JP) 2009-044015

(51) Int. Cl. G06F 15/173

(52) U.S. Cl. 709/223

(57) ABSTRACT

There is provided a wireless terminal device for performing a wireless communication. The wireless terminal device is capable of equipping a device and of communicating with a server. The wireless terminal device includes an application storage for storing an application program, an actuation request receiver for receiving an application actuation request including information specifying an application program to be started up, and an application actuator for starting up the application program on the basis of the information specifying the application program.

### CROSS-REFERENCE TO RELATED APPLICATION

This application is based upon and claims the benefit of priority of the prior Japanese Patent Application No. 2009-044015, filed on Feb. 26, 2009, the entire contents of which are incorporated herein by reference.

### FIELD

The embodiments discussed herein are related to a wireless terminal device used for wireless communication, a first server for remote-operating the device, and a second server which sends a request to the device in response to an instruction from the first server.

### BACKGROUND

Recently, some of mobile phones become increasingly sophisticated or having a various functionality such as a digital camera (hereinafter referred to as camera), a Universal serial bus (USB), and a microSD (micro secure digital card).

As the increasing of the functionality, an amount of information or data may be copied and moved such as out of a company or an enterprise by the use of the mobile phone. Accordingly, some of the functions of the mobile phones used by employees may be preferably not used in a case from the viewpoint of security in an enterprise or a company. The functions to be used may include for example the USB or the microSD.

It is known that “air download” (hereinafter referred to as ADL) is a technique for updating the software used in the mobile phone. Further, Japanese Laid-open Patent Publication No. 1996-190472 discloses a remote install system in which software is obtained without troublesome operations via transmission line and installed automatically in a terminal device. However, ADL is applied to updating the software for whole of the mobile phones, and the invention disclosed in the Patent Publication intends to update automatically the software in the terminal device.

### SUMMARY

According to an aspect of the invention, there is provided a wireless terminal device for performing a wireless communication, and capable of equipping a device and of communicating with a server, the wireless terminal device includes an application storage for storing an application program, an actuation request receiver for receiving an application actuation request including information for specifying an application program to be started up, and an application actuator for starting up the application program on the basis of the information specifying the application program.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating the configuration of a wireless terminal device and a server;

FIG. 2 is a diagram illustrating an example of a remote operating system according to a first embodiment;

FIG. 3 is a block diagram illustrating the wireless terminal device;

FIG. 4 is a diagram illustrating the operation server;

FIG. 5 is a diagram illustrating an example of data configuration stored in a user data storage;

FIG. 6 is a block diagram illustrating a push server;

FIG. 7 is a diagram illustrating an example of content in the short message service;

FIG. 8 is a diagram illustrating an example of a table depicting on and off status of the functions of the wireless terminal device;

FIG. 9 is a diagram illustrating an example of the sequence diagram which depicts the interaction among the operation server, the push server, and the wireless terminal device;

FIG. 10 is a block diagram illustrating a wireless terminal device according to a second embodiment;

FIG. 11 is a diagram illustrating an example of data configuration stored in a user data storage according to a third embodiment.

FIG. 12 is a diagram illustrating a wireless terminal device according to the third embodiment; and

FIG. 13 is a diagram illustrating an example of the sequence diagram which depicts the interaction among the operation server, the push server, and the wireless terminal device according to the third embodiment.

### DESCRIPTION OF EMBODIMENTS

The techniques described in the background may not be able to control remotely a specific user's wireless terminal device. In detail, if the specific function, such as camera functionality, of an employee's wireless terminal device is set to be operable or non-operable, the wireless terminal should be retrieved to be set the function operable or non-operable. Therefore, the troublesome operation is needed to control the function in individual wireless terminal devices. Therefore, the embodiments of the present invention are directed to provide a wireless terminal device and the server intended to control remotely a specific wireless terminal device or a wireless terminal device of a specific user.

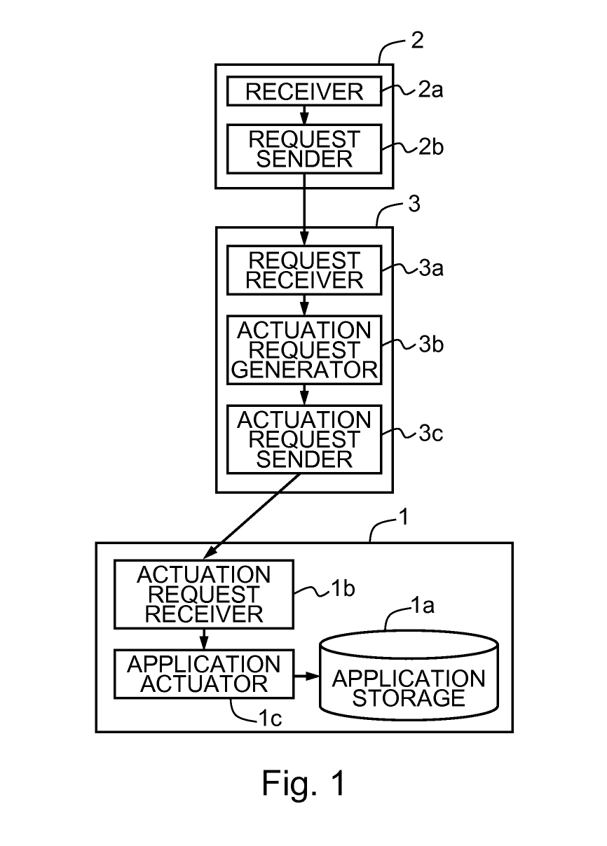

Referring to FIG. 1, the embodiment is explained. As illustrated in FIG. 1, the wireless terminal device 1 includes an application storage 1a, an actuation request receiver 1b, and an application actuator 1c. The server 2 includes receiver 2a and a request sender 2b. The server 3 includes a request receiver 3a, an actuation request generator 3b, and an actuation request sender 3c.

The receiver 2a receives data inputted by the operator for identifying the wireless terminal device which will be remotely controlled. The request sender 2b sends an operation request to the server 3, where the operation request includes information concerning an application program to be implemented in the wireless terminal device 1 specified by the operator.

The operation request is then received by the request receiver 3a in the server 3 and sent to the actuation request generator 3b. The actuation request generator 3b generates, on the basis of the operation request, an application-actuation request including the information identifying the application program to be implemented in the wireless terminal device 1

The application actuation request is received and sent to the wireless terminal device 1 by the actuation request sender 3c, on the basis of the destination information included the operation request.

The application storage 1a in the wireless terminal device 1 stores data of an application program or application programs. The data is corresponding to an application program which allows the functions equipped in the wireless terminal device 1, for example, the camera or the USB to be operable or inoperable. The application program is performed by data retrieved from the server 2.

The actuation request receiver 1b receives the application-actuation request sent to the wireless terminal device 1 from the server 3. Subsequently, the application actuator 1c runs the application program to be performed on the basis of actuation information included in the application-actuation request. Specifically, the application program for enabling or disabling the function of, for example, the camera or the USB is run or started up.

As in this way, the server 2 receives the data of the wireless terminal device 1 to be remotely controlled. Then, the server 2 transmits, to the server 3, the operation request including the information concerning the application program which is needed to be implemented in the device 1. On the basis of the operation request, the server 3 generates the application actuation request and sends the request to the wireless terminal device 1 depending on the destination information, which specifies the wireless terminal device 1, included in the operation request. Upon receiving the application actuation request, the wireless terminal device 1 starts up the application program specified by the application actuation request. By these processing, the specific wireless terminal device 1 may be remotely controlled.

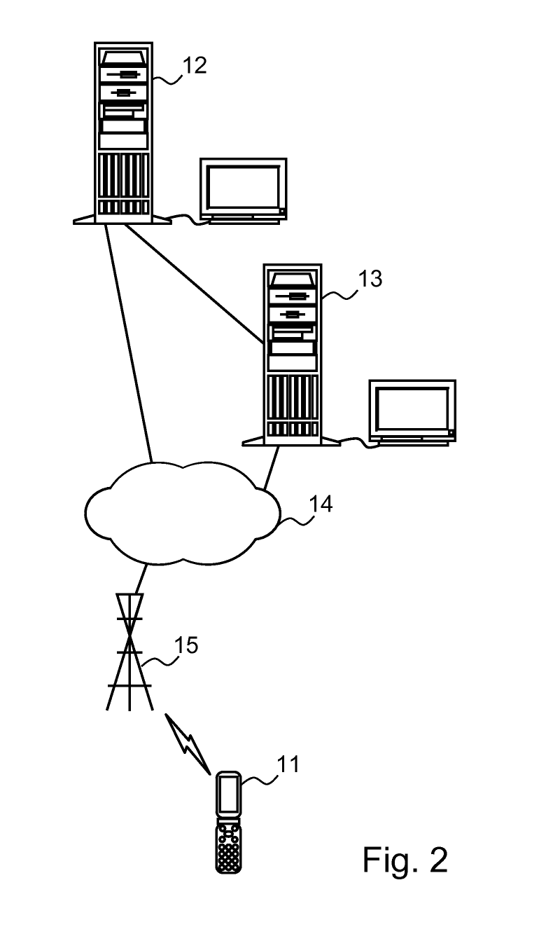

Next, the configuration of the first embodiment will be explained, referring to FIGS. 2 to 9. FIG. 2 is an exemplary configuration of a remote operation system according to the first embodiment 1. As illustrated in FIG. 2, the remote operation system includes a wireless terminal device 11, an operation server 12, a push server 13, a network 14, and a wireless base station 15.

The wireless terminal device 11 is a mobile phone including the function such as a camera, a USB, or a microSD. The wireless terminal device 11 receives a function-setting request from the operation server 12 via the push server 13, the network 14, and the wireless base station 15. Subsequently, the wireless terminal device 11 transmits a request to the operation server 12 via the wireless base station 15 and the network 14 for demanding the transmission of the function-setting data. The function-setting data includes information to enabling or disabling the function such as the camera and others equipped with the wireless terminal device 11. Upon receiving the function-setting data, the wireless terminal device 11 enables or disables the function such as the camera depending on the function-setting data.

The operation server 12 manages the function-setting data for every wireless terminal device 11, specifically for every telephone number of the wireless terminal device 11, because the operation server 12 usually manages a plurality of the wireless terminal device 11. The function-setting data is data for switching the function of the wireless terminal device 11 as described above.

The operation server 12 may be managed by a company, an enterprise or an organization for example. When the operation server 12 is managed by a company, the company may control or manage the function of the wireless terminal device 11, which is lent or provided to the employees, through the operation server 12. In this case, the operation server 12 may receive a request, inputted by an operator, for updating a function of a wireless terminal device 11 of a specific employee. Subsequently, the operation server 12 transmits a push notification request to the push server 13, where the push notification request includes a message to request the push server 13 to send a push mail to the wireless terminal device 11 of the specific employee.

The push server 13 is, for example, a push mail server operable to provide the short message service (SMS). Upon receiving the push notification request from the operation server 12, the push server 13 transmits the push mail in a form of SMS to the wireless terminal device 11 of the specific employee, where the SMS includes a function-setting request.

Upon receiving the push mail including the function-setting request from the push server 13, the wireless terminal device 11 starts up the application program corresponding to the function-setting request and sends a request to the operation server 12 for demanding the function-setting data corresponding to the function-setting request. Sequentially, the wireless terminal device 11 switches the function such as the camera on and off on the basis of the function-setting data received.

The network 14 is connected to the operation server 12, the push server 13, and the wireless base station 15 which configure or make up, for example, “Freedom of Mobile Multimedia Access” (FOMA: the trademark of NTT docomo INC.)

As wireless-communicating with the wireless base station 15, the wireless terminal device 11 may be able to communicates data with other wireless terminal device, the operation server 12, and the push server 13 through the wireless base station 15.

Referring to FIG. 2, hereinafter will be explained the case: a company manages the operation server 12 and intends, for prevention of information leakage, to switch off or disable the function of the USB and the microSD equipped in the wireless terminal device 11; the wireless terminal device is lent by the company to an employee in duty of product development division.

In this case, an operator operates the operation server 12 to generate the function-setting data for identifying the wireless terminal device 11 of the employee and for disenabling the function of the USB and the microSD equipped in the device 11. Subsequently, the operator operates the operation server 12 to transmit the push-notification request to the push server 13, where the request includes data of the phone number of the device 11 lent to the specified employee in duty of the product development division.

Upon receiving the push-notification request from the operation server 12, the push server 13 sends the push mail for the function-setting request to the wireless terminal device 11 corresponding to the data of the phone number including in the push-notification request. Accordingly, the push mail for the function-setting request is transmitted to the wireless terminal device 11 taken along by the employee.

Upon receiving the push mail transmitted by the push server 13, the wireless terminal device 11 may start up the application program corresponding to the function-setting request. The wireless terminal device 11 executes the application program to transmit the request to the operation server 12 through the wireless base station 15 and the network 14, where the request includes information demanding the function-setting data.

The operation server 12 transmits the function-setting data for disabling the function of the USB and the microSD, upon receiving the request demanding the function-setting data from the wireless terminal device 11. Then the wireless terminal device 11 receives the function-setting data from the operation server 12 and makes the USB and the microSd disable the function thereof. Accordingly, the employee as the user of the wireless terminal device 11 may not use the USB and the microSD within the device 11. Therefore will be prevented the potential information leakage using of the USB or the microSD.

As described above, the operation server 12 demands function-setting to the wireless terminal device 11 of the specific user by use of the push mail. Upon receiving the push mail, the wireless terminal device 11 starts up the application program corresponding to the demand included in the push mail to receive the function-setting data from the operation server 12. Depending on the function-setting data, the wireless terminal device 11 sets the function thereof. Accordingly, the device 11 may be controlled remotely and automatically.

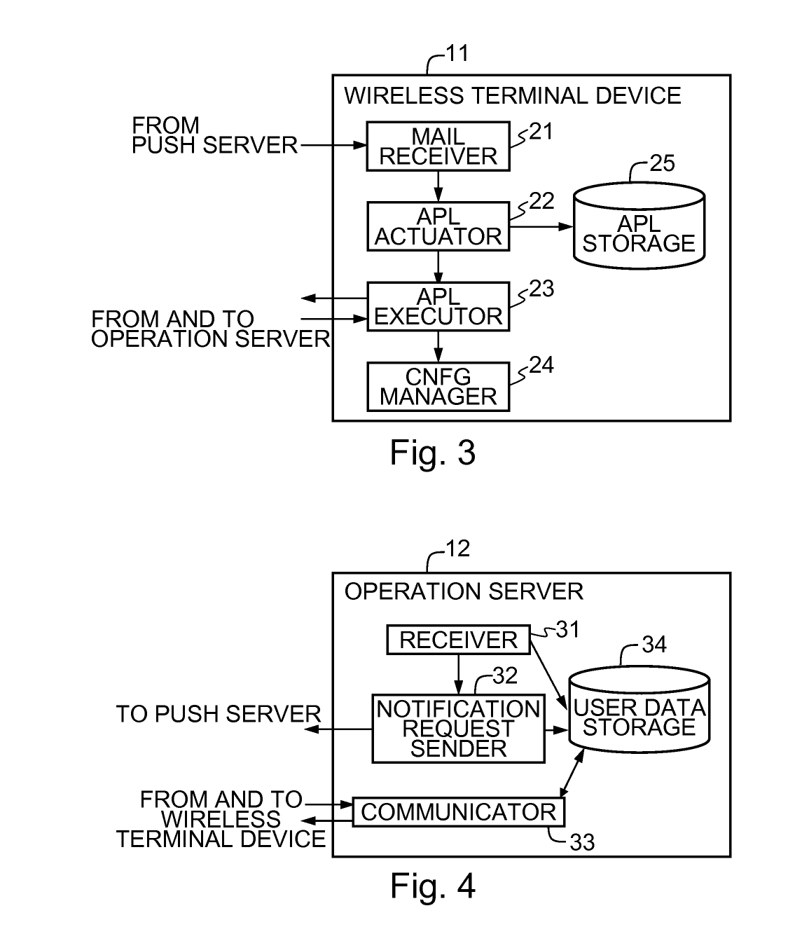

FIG. 3 is a block diagram illustrating the configuration of the wireless terminal device 11 which includes a mail receiver 21, an application actuator 22, an application executor 23, a configuration manager 24, and an application storage 25. Each of the names “application actuator,” “application executor,” “configuration manager,” and “application storage” are referred to as APL actuator, APL executor, CNFG manager, and APL storage, respectively.

The mail receiver 21 may receive the SMS push mail transmitted from the push server 13. When the mail receiver 21 receives the SMS push mail including content in a format of native platform implementation (NPF), the mail receiver 21 feeds the push mail to the APL actuator 22. The content in a format of NPF is also called as NPF content.

The SMS push mail with the NPF content includes an identifier called as an application identifier (APL-ID). Using the APL-ID in the received push mail, the APL actuator 22 may indentify the type of the received push mail. If a value of the APL-ID is “0x00001000”, the received push mail means that of the function-setting request, where x in the APL-ID is an arbitrary integer number.

The APL actuator 22 has individual path information corresponding to each of the APL-IDs, where the path information is the address specifying the area on the APL storage 25 in which the application program is stored.

For example, upon receiving the push mail including an APL-ID of “0x00001000”, the APL actuator 22 may start up the application program stored on the APL storage 25 for issuing the function-setting request. The path information is such as the pass ‘Path=\\Windows\functionsettingrequestfileDL.exe’ and the application program is such as ‘functionsettingrequestfileDL.exe’. Further, the application actuator 22 starts up another application program when a newly received push mail includes an APL-ID different from the APL-ID included in the previously received push-mail.

The application program started up by the APL actuator 22 is executed by the APL executor 23. For example, the APL executor 23 transmits the request for obtaining the function-setting data to the operation server 12 when the application program for executing the function-setting request is started up, where the application program is corresponding to the APL-ID, 0x0001000. Then the APL executor 23 receives the function-setting data transmitted from the operation server 12. Requesting and receiving the data may be executed using Internet-access service such as Mobile Operation Radio Assistant (mopera: Trade Mark of NTT docomo Inc.).

When the APL executor 23 receives the data from the operation server 12, the APL executor 23 feeds the data to CNFG manager 24. When the APL executor 23 receives the function-setting data, for example in a form of extensible markup language (XML) file, for switching the functions of the camera and the USB on or off, the APL executor 23 un-compresses the file and sends the un-compressed file to the CNFG manager 24.

The CNFG manager 24 sets the function of the wireless terminal device 11 on the basis of the data received from the APL executor 23. In detail, upon receiving the function-setting data, the CNFG manager 24 sends to a configuration service provider (CSP), which is managing or controlling the camera, the USB, and the like, the instruction for switching the function thereof on or off.

The APL storage 25 stores data for one or more application programs, for example, such as the application program for executing the function-setting request described above and an application program for confirming whether a function-setting has been performed correctly or not and notifying the confirmation result to the operation server 12.

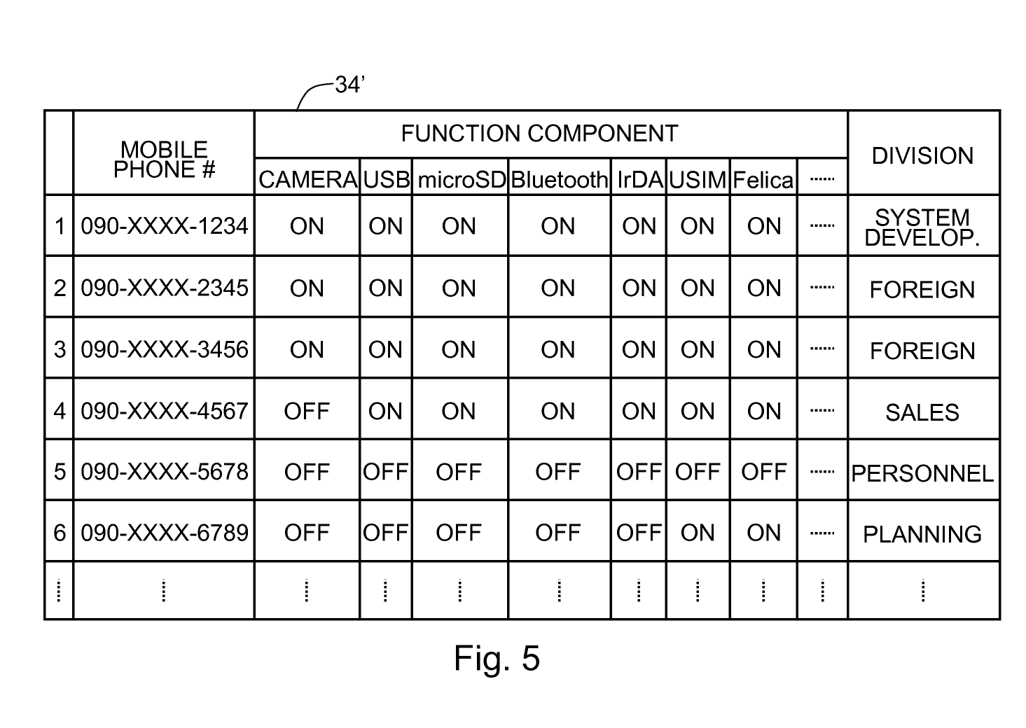

Next, referring to FIGS. 4 and 5, hereinafter will be explained the configuration of the operation server 12 and the data structure stored on the user data storage 34. The operation server 12 includes a receiver 31, a notification request sender 32, a communicator 33, and a user data storage 34 as illustrated in the block diagram in FIG. 4. An example of the data structure stored on the user data storage 34 is illustrated in FIG. 5.

Referring to FIG. 5, the data structure or table 34′ of the data stored in the user data storage 34 will be explained, where the data structure 34′ illustrates an example of the data structures. The data structure 34′ includes fields which are, for example, for the mobile phone number of a wireless terminal device, function component to be controlled, and name of division in which the user uses the mobile phone corresponding to the phone number. Further, the component field is divided into the function components to be controlled such as the camera, the USB, the microSD, the Bluetooth interface (hereinafter referred to as Bluetooth, Bluetooth is a trademark of Bluetooth SIG)), IrDA interface based on Infrared Data Association (hereinafter referred to as IrDA), User Identity Module Card (USIM), FeLiCa (Trademark of Sony Corp.), and the like.

The field of the mobile phone number includes the phone number of the wireless terminal device 11 which is used the employee of the company and controlled by the operation server 12. In the field of the function component, some of the functions included within the wireless terminal device 11. “ON” in the each field indicates that the corresponding function is available; on the contrary, “OFF” indicates that the corresponding function is unavailable.

The field of the division indicates the division name to which the employee belongs, where the employee borrows the wireless mobile terminal 11 for the use of business from the company managing the operation server 12. Returning to FIG. 4, the processing by the operation server 12 will be explained. For example, the receiver 31 receives information or data of the employee inputted by the operator of the company, which manages the operation server 12. Then data of the phone number corresponding to the employee is stored in the field of the phone number.

Further, the receiver 31 receives confirmation information of the change of function or functions of each of the wireless terminal devices 11 by operations of the operator to update the data in the field of the function or functions such as the camera, the USB and the like. For example, upon receiving the data for disabling the camera function of the wireless terminal device 11 of the employee in a certain division, the receiver 31 updates the previously set data in the field, of the device 11 of the data structure illustrated in FIG. 5, corresponding to the camera function.

Further, the receiver 31 receives the data of object for remote controlling by the operation of the operator, that is, the receiver 31 receives the type of remote control. That is, the receiver 31 receives the data, for example, for updating the function setting or for confirming the current status of function setting.

Still further, by operation of the operator, the receiver 31 receives also the data of employee of which the wireless terminal device 11 is to be controlled remotely. The notification request sender 32 receives the data of mobile phone number of the wireless terminal device 11 from the user data storage 34 when the receiver 31 receives the data of the type of remote control and the data of the employee of which the wireless terminal device 11 will be controlled remotely. Subsequently, the notification request sender 32 sends the push notification request to the push server 13, where the push notification request includes the information of the type of remote control and the mobile phone number of the wireless terminal device 11 borrowed by the employee.

Next, upon receiving the data transmission request from the wireless terminal device 11, the communicator 33 sends the data to the device 11. In more detail, when the communicator 33 receives the transmission request for the function setting, the communicator 33 fetches, from the user data storage 34, the function-setting data of the employee indicated by the data inputted by the operator to send the wireless terminal device 11. For example, assuming that the receiver 31 receives the request to send push mail or push mails to the employees of the development division and the sales division according to the data inputted by the operator, the communicator 33 receives the individual data for setting function(s) of each wireless terminal device 11 of the employees form the user data storage 34. Then the communicator 33 transmits the individual data in a form of XML file to each of the wireless terminal devices 11.

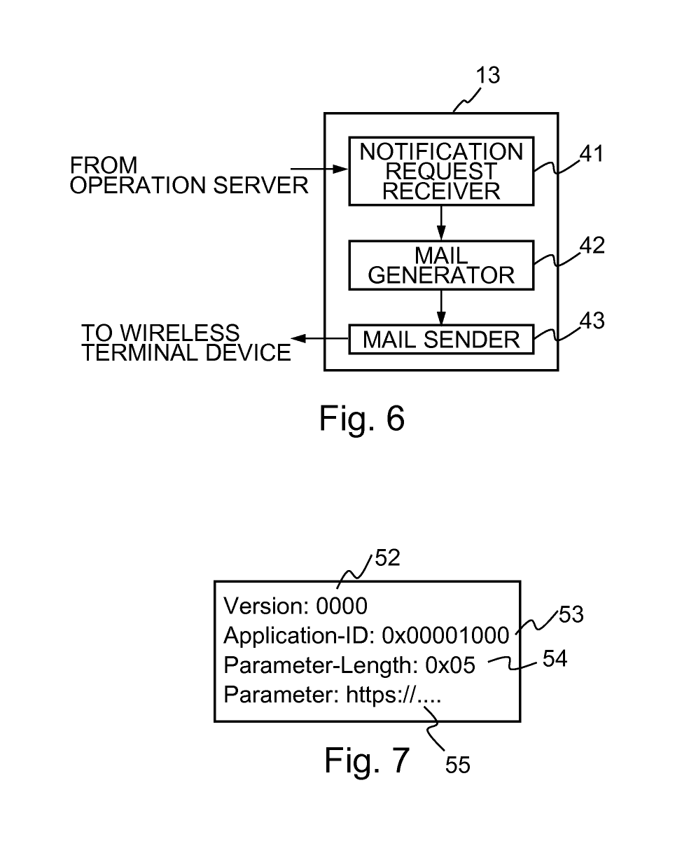

Referring to FIG. 6 illustrating the block diagram of the push server, the push server 13 is explained below. The push server 13 includes the notification request receiver 41, the mail generator 42, and the mail sender 43. The notification request receiver 41 has a function for receiving the push-notification request from the operation server 12 and for notifying the reception of the push-notification request to the mail generator 43.

The notification request receiver 41 receives the push-notification request, and then the mail generator 42 composes the push mail in a form of SMS based on the content of the received push-notification request. As the push-notification request includes the data of the remote-control type as described above, the mail generator 42 composes the push mail so that the identifier corresponding to the remote-control type is included in the data in APL-ID. For example, when the push notification request includes information of the remote-control type for updating the function-setting, the APL-ID is set to include the data 0x00001000 by the mail generator 42.

Subsequently, the mail sender 43 sends the push mail generated by the mail generator 42 to the wireless terminal device 11. As the push notification request includes the mobile phone number corresponding to the wireless terminal device 11 borrowed by the employee, the mail sender 43 is capable of sending correctly the composed push mail to the wireless terminal device 11.

Here, referring to FIG. 7, the NPF content in the SMS will be explained. The push mail includes SMS header, Wireless Datagram Protocol (WDP) header, Wireless Session Protocol header, and the NPF content. FIG. 7 illustrates the NPF content which include a set of data of the version 52, the application-ID (APL-ID) 53, the parameter-length 54, and the parameter 55.

The version 52 is the content number 0000 and fixed. The application-ID 53 includes the identifier indicating the application type started up by the wireless terminal device 11. The parameter-length 54 specifies the data length of the parameter 55 which is the uniform resource locater (URL) of the server to which the wireless terminal device 11 will accesses to fetch the function-setting data.

In more detail, when the mail generator 42 in the push server 13 (refer to FIG. 6) receives the notification request for remotely controlling the function setting by the operation server 12, the mail generator 42 specifies the data 0x00001000 as APL-ID 51. Further, the mail generator 42 specifies the URL of the operation server 12 as the URL to be accessed by the wireless terminal device 11 to fetch the function-setting data.

As described above, the wireless terminal device 11 may be capable of staring up and executing the application program for the function-setting request when receiving the push mail including the NPF content illustrating in FIG. 7. Further, the APL executor 23 in the wireless terminal device 11 may be capable of accessing to the operation server 12 based on the URL specified by the parameter 55 and of downloading the function-setting data such as data for switching the camera on and off.

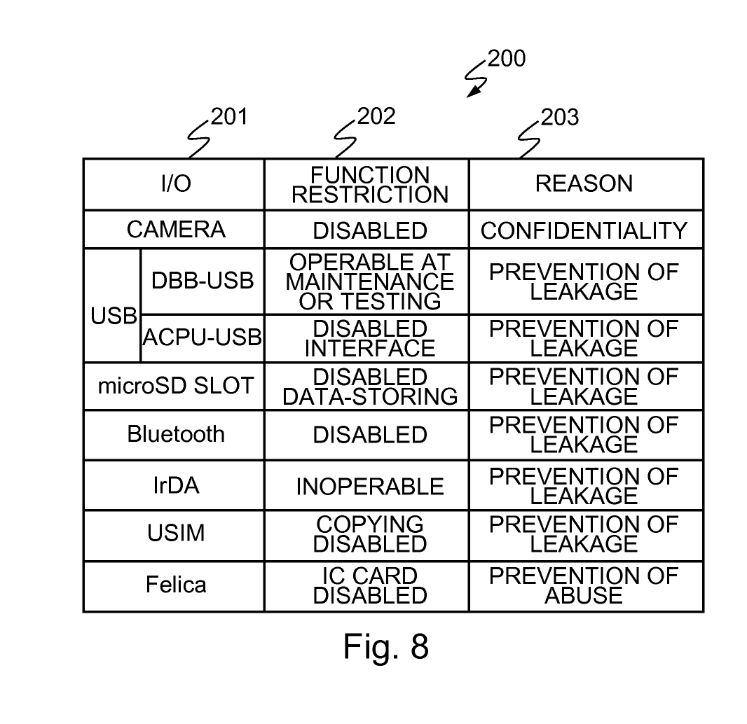

FIG. 8 is a table 200 illustrating an example of the detail of on and off status of the functions of the wireless terminal device 11. Referring to FIG. 8, in the input/output (I/O) column 201 of the table 200 are listed the commonly used I/O devices mountable within the wireless terminal device 11, where I/O device is for example the camera and storage medium such as the USB, or microSD.

In the function restriction column 202 are listed the example of restriction functions corresponding to the I/O devices listed in the table 200. For example of the microSD, the restriction function is disabling the interface for the microSD not to store data therein. In the reason column 203 are listed the example of the reasons for restricting the corresponding to the functions. For example of the microSD, the reason for the restricting the use thereof is based on preventing the potential information leakage such as telephone number list of the customers or the like

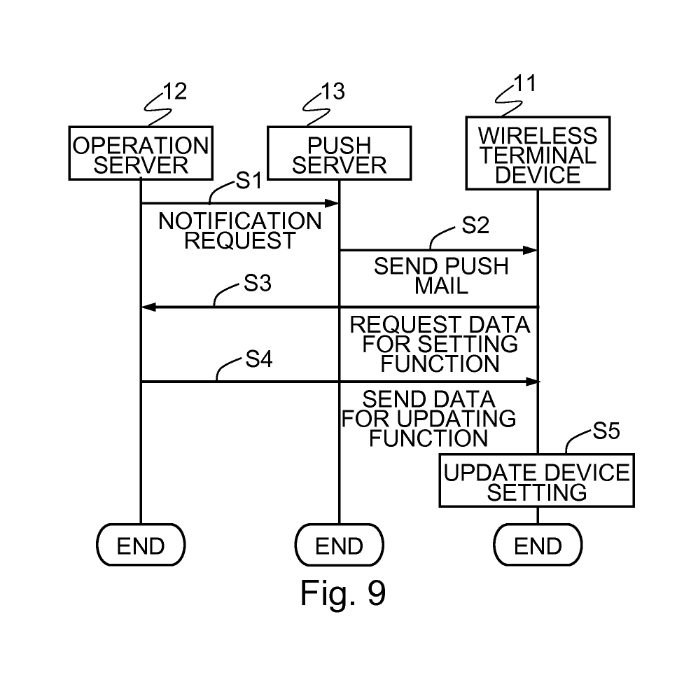

FIG. 9 illustrates an example of the sequence diagram which depicts the interaction among the operation server 12, the push server 13, and the wireless terminal device 11. The sequence diagram in FIG. 9 illustrates the sequence in the case of updating the function setting of the wireless terminal device 11. The operation server 12 receives the request data the function updating inputted by the operator of the company for updating function of a specific wireless terminal device 11, and then sends the push notification request to the push server 13 (in Step S1). The push notification request includes the data of a telephone number corresponding to the specific wireless terminal device 11 using by an employee and a type of remote control for updating the function.

Upon receiving the push notification request, the push server 13 generates a push mail in a form of SMS, where an APL-ID in the push mail is set to the data 0x00001000 according to the type of remote control included in the push notification request. Subsequently, the push server 13 sends the generated push mail to the wireless terminal device 11 as a destination of which an address is the telephone number included in the push notification request (in Step S2).

Upon receiving the push mail form the push server 13, the wireless terminal device 11 starts up the application program according to the APL-ID 0x00001000 to execute the updating function-setting of such as the camera within the device 11. Upon starting up the application program, the wireless terminal device 11 sends the function-setting data request to the operation server 12 (in Step S3).

Subsequently, upon receiving the request for function-setting data from the wireless terminal device 11, the operation server 12 sends the function-setting data corresponding to the data input by the operator for updating the function in the wireless terminal device 11 (in Step S4)

Upon receiving the function-setting data from the operation server 12, the wireless terminal device 11 controls the CSP on the basis of the received function-setting data to turn the functions of such as the camera and the USB on and off, or to enable or disenable the functions (Step S5). As described above, the operation server 12 sends the push-notification request to the push server 13 according to the request by the operator. The push server 13 sends the push mail in a form of SMS to the wireless terminal device 11. Upon receiving the push mail, the wireless terminal device 11 starts up the specific application program based on the received push mail to send the request of the function-setting data from the operation server 12. Then, the wireless terminal device 11 receives the function-setting data form the operation server 12. As a result, the function or functions within the wireless terminal device 11 may be remotely controlled automatically or without operations by the user of the device 11.

Further, the company may remotely update the function(s) of a specific wireless terminal device through the operation server 12 without collecting the specific wireless terminal device to update the function(s) such as of the camera and the USB mounted or mountable within the specific wireless terminal device assembled.

Further, the wireless terminal device 11 receives information of the application program to be started up through the push mail and starts up the application program, then the device 11 updates the setting of the required function using data-communication with the operation server 11. The manner described above will enhance security when updating the function(s) of the specific wireless terminal device. On the other hand, if the push mail is directly sent with the function-setting data, the function of wireless terminal device may be updated without permission or with ill intention through the function-setting data sent by someone.

Further, the security may be improved by setting number of times for updating the function to one, for example. In more detail of this case, once the function of I/O such as the camera or the USB has been turned to off, the turned function will not be changed. That is, the APL actuator 22 (see FIG. 3) will not actuate the application program once started up or executed even if the wireless terminal device 11 receives the push mail including the APL-ID for requesting to start up the application program.

In the example described above, the operation server 12 sends the push-notification request to the push server 13, and then the push server 13 generates a push mail. However, it is preferable also that the operation server 12 generates a push mail destined to the wireless terminal device 11 such as a company mobile phone lent to an employee and sends the push mail to the wireless terminal device 11 through the push server 13. In latter case, the operation server sets the APL-ID and/or various parameters in the push mail.

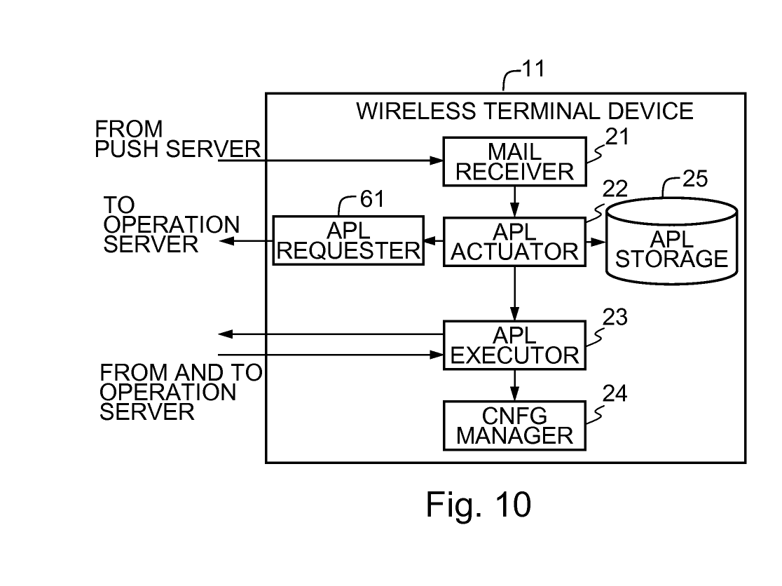

Next, the second embodiment will be explained in detail, referring to FIG. 10. In the second embodiment, the wireless terminal device 11 has not a path corresponding to the APL-ID included in the received push mail, that is, the wireless terminal device 11 has not stored the application program which is requested to be started up.

FIG. 10 is a block diagram illustrating the wireless terminal device 11 according to the second embodiment, in FIG. 10 the same references 11, 21 to 25 have been used as in FIG. 3 for similar elements, while an APL requester 61 is additionally included in FIG. 10. Explanations on the elements with same reference in FIG. 3 are omitted for briefness.

In the second embodiment, when the wireless terminal device 11 has no path information corresponding to a received APL-ID, the APL actuator 22 sends a notification for informing the APL requester 61 of the matter. Upon receiving the notification, the APL requester 61 accesses to a server storing the application program corresponding to the APL-ID, where an address such as a Uniform Resource Locator (URL) for accessing to the server has been stored within the wireless terminal device 11.

The server storing the application program may be the operation server 12. In the case that the operational server 12 stores the application program, the APL requester 61 may access the operational server based on a URL as a parameter of content in the format of Native Platform Implementation (NPF).

When accessing the server in which the application programs are stored, the APL requester 61 sends to the server the data of the APL-ID included in the received push mail. Using the data of the APL-ID, the server may identify the application program which the APL requester has requested.

The operation of the wireless terminal device 11 illustrated in FIG. 10 will be described below in detail. The detail explanation is directed in the case that the operator for the operation server 12 tries to confirm that the wireless terminal device 11 has been set, for example a function or functions h as instruction or instructions inputted by the operator.

As described above, the operation server 12 sends to the push server 13 the push-notification request for confirming status of function set in the wireless terminal device 11. Upon receiving the push-notification request, the push server 13 delivers the push mail in a form of SMS according to the received push-notification request. The push mail includes the information of the APL-ID 0x00002000 which specifies the application program for confirming the status of a function being set to on or off in the wireless terminal device 11.

Upon receiving the push mail from the push server 13, the APL actuator 22 explores, within the wireless terminal device 11, the path information corresponding to the APL-ID 0x00002000 included in the push mail. In this case, it is supposed that no path information is detected, namely, the application program for confirming the status of function being set is not stored in the APL storage 25. As a result of exploring no path information to the application program required by the push mail, the APL actuator 22 notifies the APL requester 61 of no path information to the application program specified by the APL-ID of 0x00002000.

Upon receiving a notification from the APL actuator 22, the APL requester 61 accesses a server storing the application program for confirming the status of function being set based on previously stored data of URL. The APL requester 61 receives the data of the application program from the server. Then the data of the application program is stored on the APL storage 25. Further the APL requester 61 generates the path information and stores data of both the path information and the APL-ID information linked each other.

Accordingly, the APL actuator 22 may start up next time the application program for confirming the status of a function being set when receiving the push mail including the APL-ID identifying the application program.

As described above, the wireless terminal device 11 may access the server storing an application program depending on a starting up request if the application program is not stored within the device 11, and may receive the data of the application program. Therefore, the wireless terminal device 11 may execute an application program even if the device 11 does not store the application program.

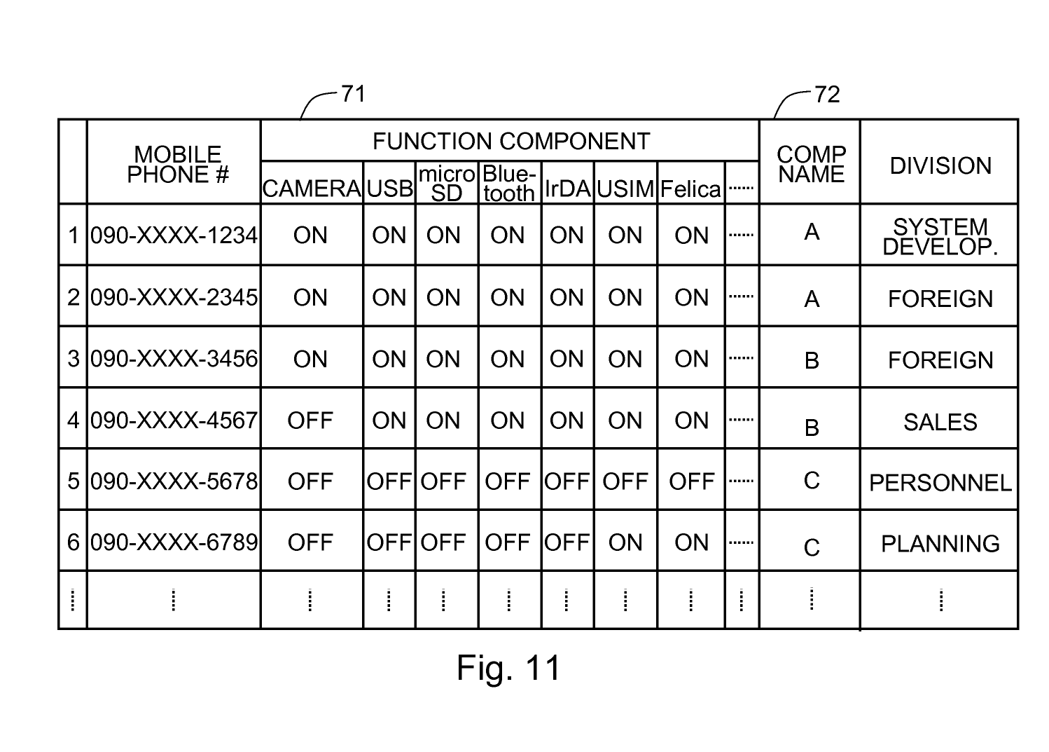

Next, the third embodiment will be explained by referring to FIG. 11. One of the features of the third embodiment is intended, for example, that wireless terminal devices 11 belonged to a plurality of companies are managed by a system, where each of the wireless terminal devices 11 is used by an employee belonged to individual company. The system or a server may be managed by a company which provides the service for managing the functions of each of the wireless terminal devices 11. The company providing the service, for example, sales the wireless terminal devices 11 and manages also the functions thereof.

The third embodiment includes also the wireless terminal device 11, the operation server 12, and the push server 13 which are same or similar to those illustrated in FIGS. 3, 4, and 6. The exemplary configuration of the data structure 71 stored in the user data storage 34 is illustrated in FIG. 11. As depicted in FIG. 11, the data structure 71 includes the field 72 for storing data of company name.

As the data structure 71 has the field 72, the operation server 12 illustrated in FIG. 4 may accept the data for remote controlling the function of the wireless terminal device 11 of a specific company. Inputting the data of the company name, the operation server may start to execute updating the function of the device(s) 11 of the specific company, that is, the wireless terminal device(s) used by an employee or employees of the specific company.

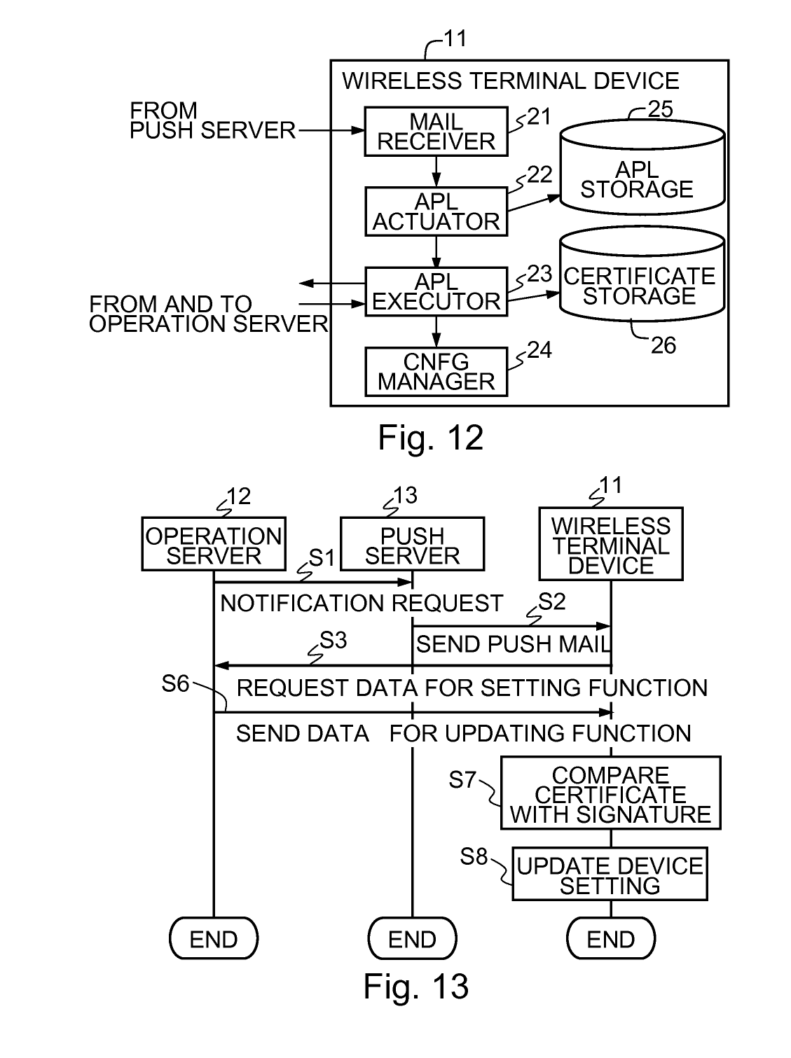

Next, the third embodiment will be explained referring to FIG. 12, where similar function or part to one in FIG. 3 has same reference number of that in FIG. 3 and the explanation(s) thereof is omitted for avoiding redundant descriptions. In the third embodiment, as the wireless terminal devices 11 of a plurality of companies are managed, it is preferable to take stronger measures for erroneous operation such as erroneous inputting of a company name. Accordingly, the APL executor 23 may include a function executing authentication on the received data from the operation server 12a. In detail, the wireless terminal device 11 further includes the electronic certification data storage (or the authentication data storage) 26 in the configuration illustrated in FIG. 12. The electronic certification data storage 26 stores preliminarily the data such as the identification number of the company as the data of the electronic certification, where the employee of the company uses the wireless terminal device 11.

Referring to FIG. 13, the process of the wireless terminal device 11 illustrated in FIG. 12 will be explained. The Steps S1 to S3 are similar to the steps S1 to S3 in FIG. 9 and the explanations therefor are omitted for avoiding redundant descriptions. The operation server 12 sends the function updating data to the wireless terminal device 11 according to the request from the device 11 which is used by an employee of a company. In this case of the third embodiment, the function updating data includes the signature data (as the authentication data), such as the identification data, of the company (Step S6).

Upon receiving the function updating data, the APL executor 23 compares the signature data in the function updating data with the electronic certification data stored in the electronic certificate data storage 26 (Step S7). If the signature data and the electronic certification data agree each other, the APL executor 23 executes function updating such as switching the functions of the camera and the USB on or off depending on the received function updating data, while the APL executor 23 deletes the received function updating data when the signature data and the electronic certification data do not agree each other (Step S8).

As described above, since the operation server 12 may send the function updating data including the electronic certificate data, the wireless terminal device 11 will delete the received function updating data and end the process when the signature data and the electronic certification data do not agree each other. Accordingly, the function updating data will be prevented from an erroneous delivery to a wireless terminal device 11.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A wireless terminal device for performing a wireless communication, and capable of equipping a device and of communicating with a server, the wireless terminal device comprising:
an application storage for storing an application program;
an actuation request receiver for receiving an application actuation request including information for specifying an application program to be started up; and
an application actuator for starting up the application program on the basis of the information specifying the application program.

2. The wireless terminal device according to claim 1, further comprising a configuration manager for controlling the device on the basis of data received from the server, the received data requested by executing the application program.

3. The wireless terminal device according to claim 1, wherein the application actuator starts up the application program only once.

4. The wireless terminal device according to claim 1, wherein the application actuation request is sent in a form of a push mail.

5. The wireless terminal device according to claim 1, further comprising an application requester for requesting the application program to an application server storing the application program when the application program is not stored in the application storage.

6. The wireless terminal device according to claim 1, further comprising an authentication data storage for storing authentication data, wherein the application actuator compares the authentication data with authentication data included in data received from the server.

7. A server for controlling remotely a wireless terminal device, the server capable of communicating with a notification server, comprising:
a receiver for accepting selection data for selecting the wireless terminal device; and
a request sender for sending, to the notification server, an operation request which includes information regarding an application program to be started up on the wireless terminal device.

8. A server for sending a starting up request to a wireless terminal device to start up an application program upon request from an operation server for controlling remotely the wireless terminal device, the server comprising:
a request receiver for receiving an operation request sent from the operation server to the wireless terminal device;
a start up request generator for generating, on the basis of information included in the operation request, a start up request including information on an application program to be started up on the wireless terminal device; and
a start up request sender for sending the start up request to the wireless terminal device on the basis of address information specifying the wireless terminal device, the address information being included in the start up request.
